(19) United States
(12) Patent Application Publication
(10) Pub. No.: US 2004/0065073 A1
(43) Pub. Date: Apr. 8, 2004

(54) Flexible recuperator mounting system

(75) Inventor: James S. Nash, North Hampton, NH (US)

Correspondence Address: MICHAEL BEST & FRIEDRICH LLP, 3773 CORPORATE PARKWAY, SUITE 360, CENTER VALLEY, PA, 18034-8217, US

(73) Assignee: Ingersoll-Rand Energy Systems Corporation, Portsmouth, NH

(21) Appl. No.: 10/266,349

(22) Filed: Oct. 8, 2002

(51) Int. Cl. F02C 7/10

(52) U.S. Cl. 60/39.511

(57) ABSTRACT

A recuperator support includes a first pivot mount that defines a first pivot axis and a floating pivot mount that defines a floating pivot axis. The recuperator is coupled to the pivot mounts and pivotal about the pivot axes. The floating pivot mount accommodates thermal growth of the recuperator. The first pivot mount may be mounted to a frame such that the first pivot axis is fixed with respect to the frame.

### BACKGROUND OF THE INVENTION

The present invention relates to a flexible recuperator mounting system that accommodates thermal growth of a recuperator and accommodates significant shock loads. While useful in substantially any recuperator system, the present invention has particular application to a support system for a recuperator in a power generation system aboard a sea-going ship (e.g., a freighter, cruise ship, or warship).

### SUMMARY OF THE INVENTION

The invention provides a recuperator support that includes a first pivot mount that defines a first pivot axis, and a floating pivot mount that defines a floating pivot axis. A recuperator is pivotally coupled to the first pivot mount and the floating pivot mount. During thermal expansion of the recuperator, the recuperator pivots about the first and floating pivot axes, and the floating pivot axis moves with respect to the first pivot axis. A second recuperator may be coupled to a second pivot mount and coupled to the floating pivot mount such that the first and second recuperators at least partially support one another.

### BRIEF DESCRIPTION OF THE DRAWINGS

The detailed description particularly refers to the accompanying figures in which:

FIG. 1 is a schematic representation of a combustion turbine system embodying the present invention.

FIG. 2 is a perspective view of a partially stacked recuperator core.

FIG. 3A is a front sectional view of a support structure supporting two recuperators.

FIG. 3B is an illustration of the support structure and recuperators of FIG. 3A after undergoing thermal expansion.

FIG. 4 is a partial perspective view of the lower portion of the support structure.

FIG. 5 is a perspective view of a latch mechanism for the lower portion of the support structure.

FIG. 6A is a sectional view of the latch mechanism in a receiving position.

FIG. 6B is a sectional view of the latch mechanism in an capturing position.

FIG. 7 is a partial perspective view of the upper portion of the support structure.

FIG. 8 is a partial exploded perspective view of the upper portion of the support structure.

FIG. 9 is a front sectional view of another construction of the support structure supporting a single recuperator.

FIG. 10 is a partial perspective view of the upper portion of the support structure of FIG. 9.

FIG. 11 is a front sectional view of another construction of the support structure supporting two recuperators.

FIGS. 12-16 are schematic illustrations of other constructions of the recuperator support.

### Detailed Description

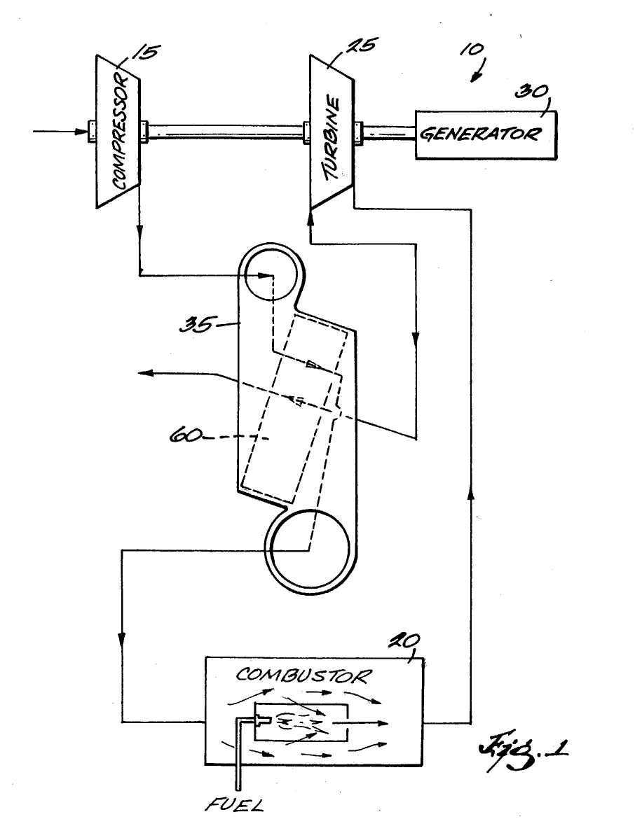

As shown schematically in FIG. 1, a turbine or microturbine engine 10 includes a compressor 15, a combustor 20, a turbine 25, a generator 30, and a recuperator or heat exchanger 35. The turbine 25, generator 30, and compressor 15 include rotary elements, either directly or indirectly coupled to one another so that rotation of the turbine rotary element produces a corresponding rotation of the generator and the compressor rotary elements. Alternatively, the turbine 25 may include a dedicated power turbine for the generator 30 and a dedicated gasifier turbine for the compressor 15. Rotation of the compressor rotary element draws atmospheric air into the compressor 15 so that the compressor 15 may pressurize the air. The compressor 15 discharges the air to the cool flow path of the recuperator 35 for preheating.

The preheated compressed air exits the recuperator 35 and enters the combustor 20 where it mixes with a fuel (e.g., propane, kerosene, natural gas, gasoline, diesel, etc.). Alternatively, the fuel may be mixed with the air at the compressor 15 intake. The fuel-air mixture is ignited and combusted within the combustor 20 to produce a hot flow of products of combustion. The products of combustion flow through the turbine 25, transfer thermal and kinetic energy to the turbine 25, and induce rotation of the rotary elements of the turbine 25, generator 30, and compressor 15. The turbine 25 thus supplies the rotary energy needed to drive the compressor 15, with excess energy driving the generator 30 to produce a current of electricity.

The turbine exhaust gas, which is still quite hot, enters the hot gas flow path of the recuperator 35 where it preheats the compressed air in the recuperator 35 to raise the efficiency of the combustor 20. The recuperator 35 is heated by the exhaust gas, which results in thermal growth of the recuperator 35, as will be discussed in more detail below. After exiting the recuperator 35, the exhaust gas is vented to the atmosphere or is further processed or used for cogeneration of hot water or some other useful purpose.

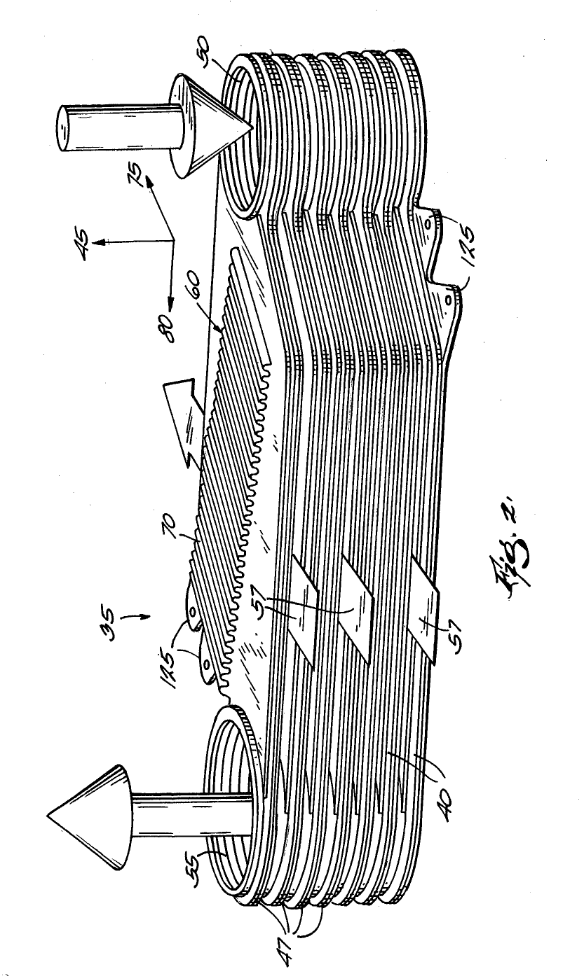

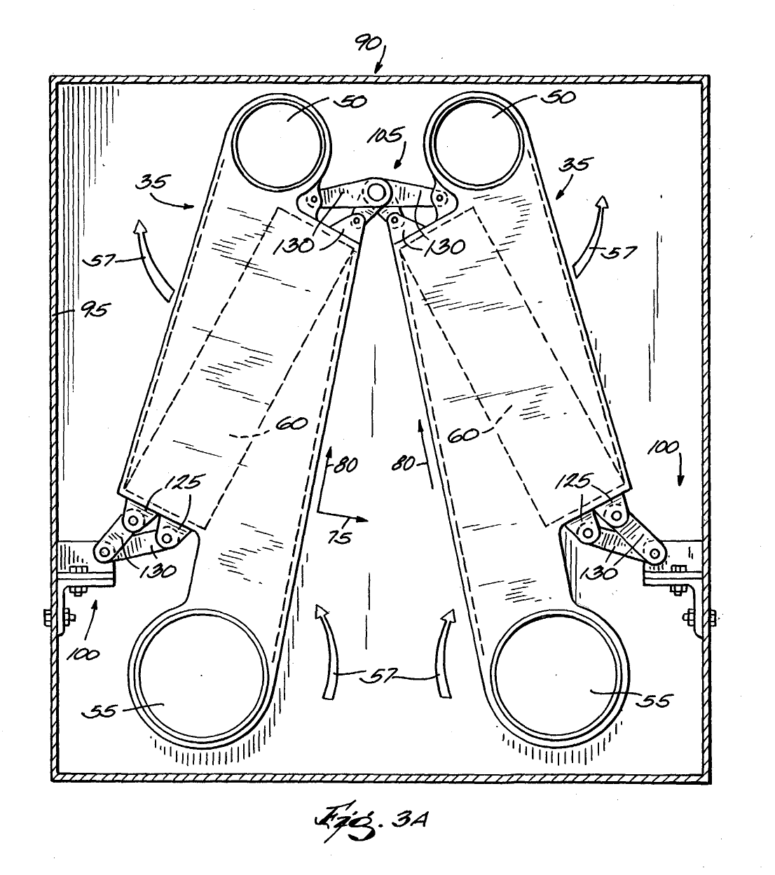

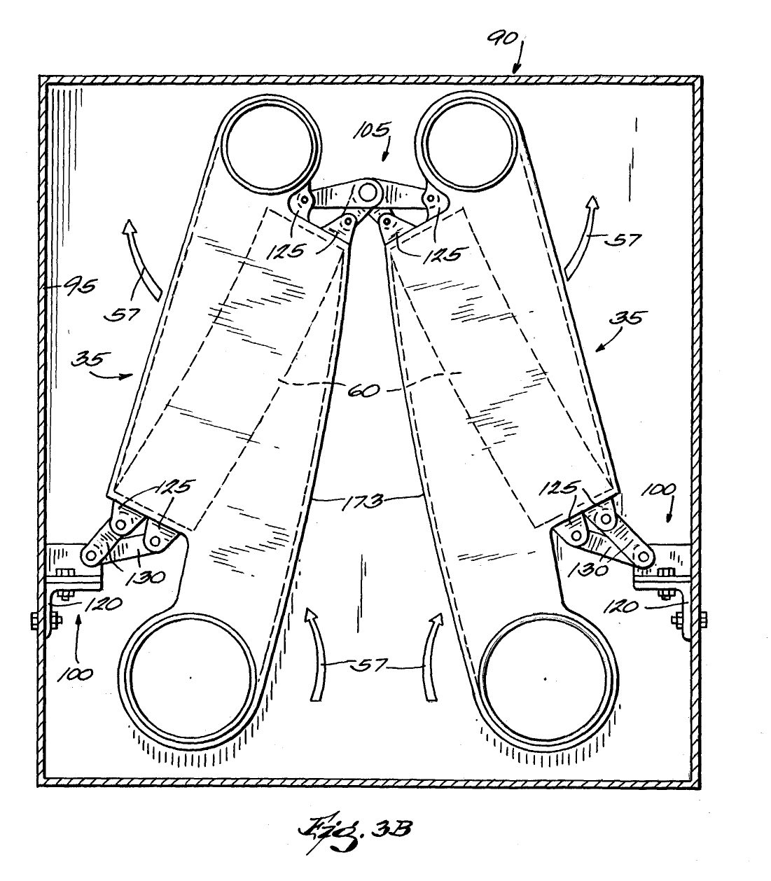

FIG. 2 illustrates the core portion of the recuperator 35. The recuperator core is of the type disclosed in U.S. Pat. No. 5,983,992, the entire contents of which are incorporated herein by reference. The recuperator core includes a plurality of heat exchange cells 40 stacked in a stackwise direction 45. Each heat exchange cell 40 includes two plates sealed to one another along a seam 47 running around the periphery of the cell 40. The cells 40 define inlet and outlet manifolds 50, 55 that communicate with each other through an internal flow path within the cells 40. Between the cells 40 are exhaust gas flow paths for the flow of hot turbine exhaust gas (as illustrated at 57 in FIGS. 2, 3A, and 3B).

The preheated compressed air enters the internal flow paths of the cells 40 through the inlet manifold 50, is heated by the exhaust gas, and exits the cells 40 through the outlet manifold 55. The recuperator core includes a matrix portion 60 (FIGS. 1, 2, 3A and 3B) in its center, where the exhaust gas and compressed air flow in substantially opposite (i.e., counterflow) directions. Most of the heat transfer within the recuperator 35 occurs in the matrix portion 60. The heat transfer may be enhanced by metallurgically bonding matrix fins 70 outside and inside the cells 40 in the matrix portion 60.

The recuperator 35 grows and shrinks in response to temperature changes (i.e., heating and cooling, respectively). This thermal growth and shrinkage (collectively referred to as “thermal expansion” herein) occurs in the stackwise direction 45, a width direction 75, and a height direction 80 (FIGS. 2 and 3A). Temperature changes occur when the engine 10 is started, when load on the engine is changed, and in response to changes in other operating parameters.

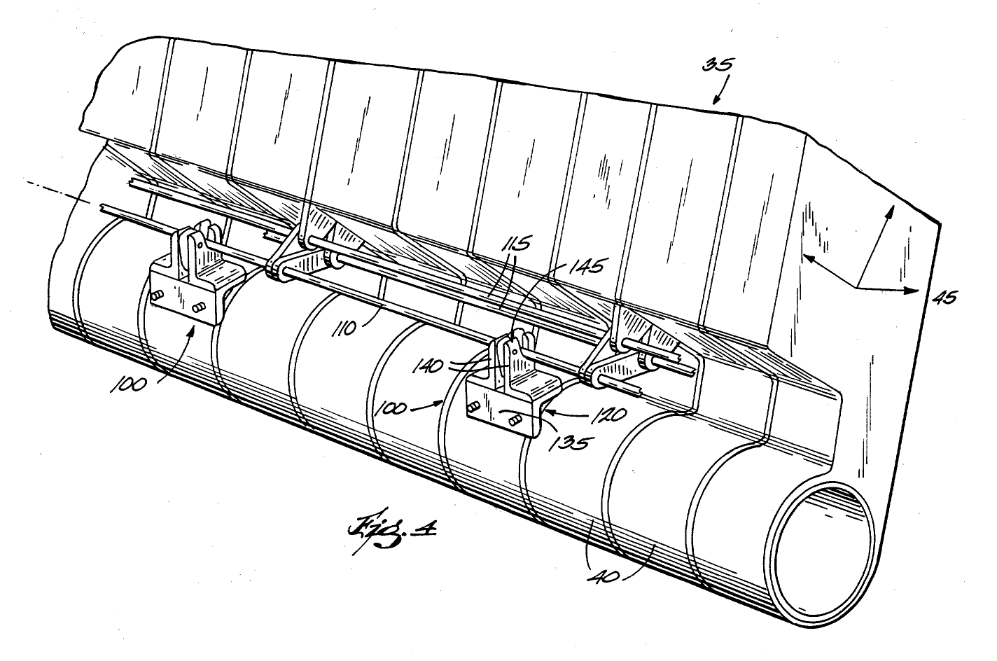

FIGS. 3-8 illustrate a recuperator support 90 including a frame 95, a plurality of lower mounting assemblies 100, and a plurality of upper mounting assemblies 105. The frame 95 may be fabricated from structural components such as plate, bars, beams, etc. welded, bolted, or otherwise joined together. Alternatively, the frame 95 or a portion of the frame may include the walls, floor, or ceiling of the ship or room in which the frame 95 resides. The lower mounting assemblies 100 support the lower portions of first and second recuperators 35, and the upper mounting assemblies 105 interconnect the top portions of the first and second recuperators 35 to each other. In this regard, the recuperators 35 lean against each other in an A-shaped configuration. It should be noted that much of the detail of the recuperators 35 illustrated in FIGS. 4-16 has been omitted for the purpose of better illustrating the recuperator support 90.

FIGS. 4-6 best illustrate the lower mounting assemblies 100. Because the lower mounting assemblies 100 are substantially identical to each other, only one of them will be discussed. The lower mounting assembly 100 includes a fixed-position pivot rod 110, a pair of tension rods 115, an angle bracket assembly 120, a pair of plate extensions 125, and a pair of arms 130.

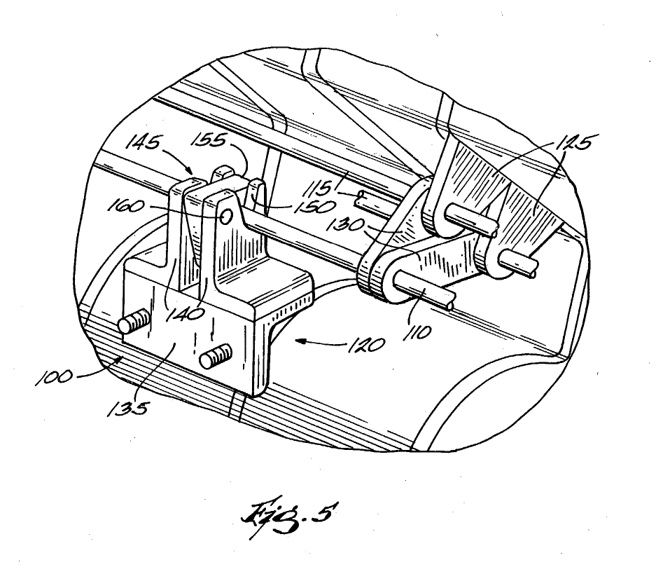

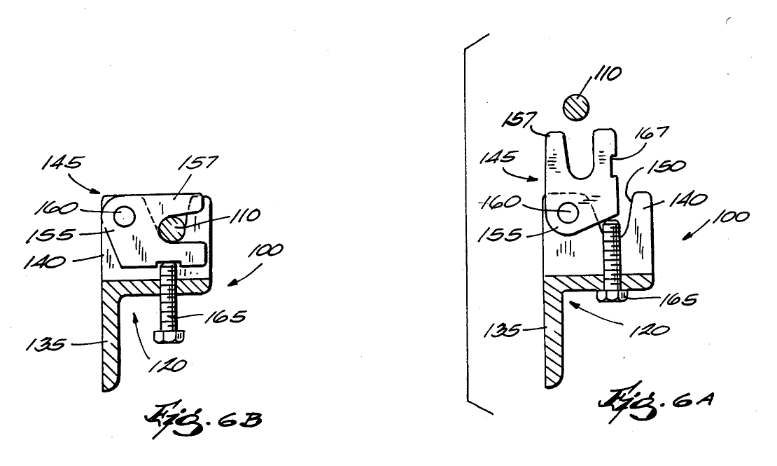

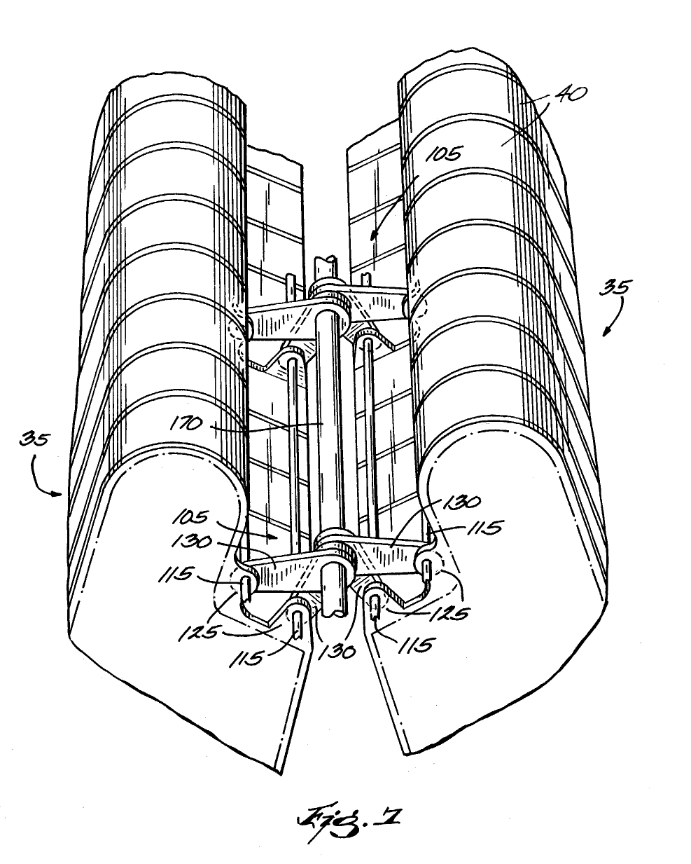

The fixed-position pivot rod 110 and tension rods 115 extend substantially the entire stackwise 45 depth of the recuperator 35. The angle bracket assembly 120 includes an angle bracket 135, a pair of forked members 140, and a latch assembly 145. The angle bracket 135 is mounted to the frame 95 with suitable mounting hardware, such as the illustrated bolts or studs. The forked members 140 are mounted to the top of the angle bracket 135 and define upwardly-opening slots 150 (FIGS. 5 and 6A) that receive the fixed-position pivot rod 110.

With reference to FIGS. 5, 6A, and 6B, the latch assembly 145 includes a latch member 155 pivotally mounted between the forked members 140, a pivot pin 160, and a locking bolt 165. The latch member 155 includes a nose portion 157 and pivots on the pivot pin 160 between a receiving position (FIG. 6A) and a capturing position (FIG. 6B). When in the capturing position, the nose portion 157 of the latch member 155 captures the fixed-position pivot rod 110 within the slots 150 and resists removal of the fixed-position pivot rod 110 therefrom.

When moved to the receiving position, the yoke of the latch member 155 opens upwardly to receive the fixed-position pivot rod 110 and does not hinder its removal from the slots 150. The bolt 165 holds the latch member 155 facing upward to receive the pivot rod 110. After placing the pivot rod 110 into the latch member 155, the bolt 165 is retracted, thereby permitting the pivot rod 110 to lower into a captured state within the slots 150 while the nose portion 157 of the latch member 155 pivots across the slots 150. The bolt 165 is then retightened so that it engages a cut-out 167 in the latch member 155 to resist rotation of the latch member 155 to the receiving position.

The plate extensions 125 extend from the seam 47 of one of the cells 40, where the top and bottom plates of the cell 40 are joined, and the plate extensions 125 are preferably integral with one or both of the plates. The plate extensions 125 include holes that pivotally receive the tension rods 115. The arms 130 have holes at their ends that pivotally receive the tension rods 115 and the fixed-position pivot rod 110.

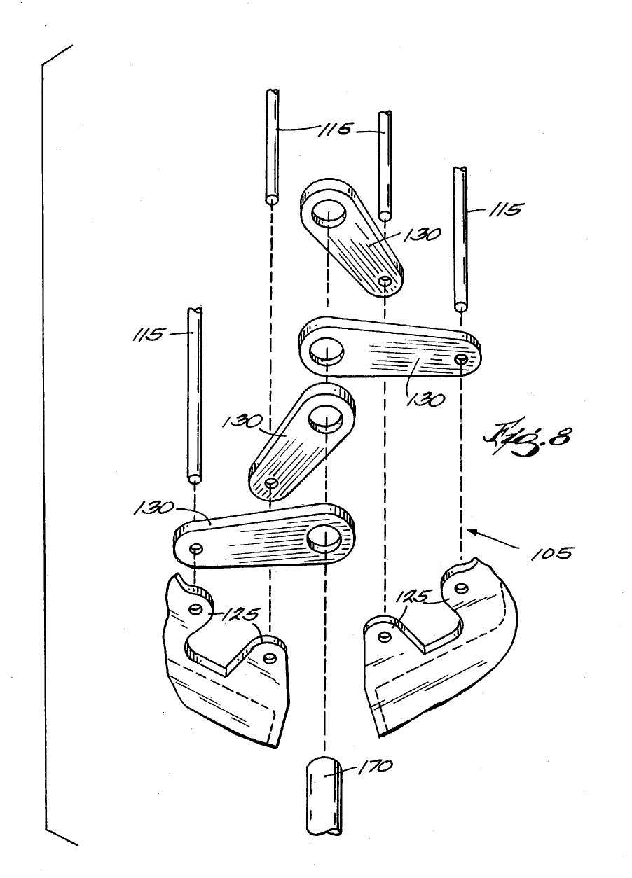

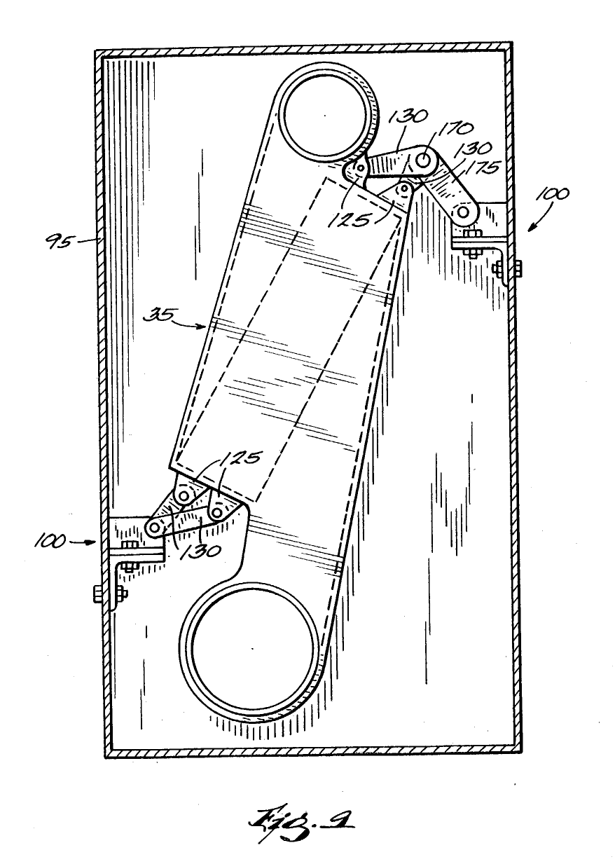

FIGS. 7 and 8 illustrate the upper mounting assemblies 105. Because the upper mounting assemblies 105 are substantially identical to each other, only one of them will be discussed. The upper mounting assembly 105 supports both recuperators 35, and therefore includes four plate extensions 125 (two on each recuperator 35), four tension rods 115, and four arms 130, all of which are similar to their counterparts in the lower mounting assembly 100 described above. The upper mounting assembly 105 also includes a single floating pivot rod 170 to which one end of each of the four arms 130 is pivotally mounted. The recuperators 35 lean against each other through the floating pivot rod 170.

Based on the foregoing, the fixed-position pivot rods 110 define first and second pivot axes, and the floating pivot rod 170 defines a floating pivot axis. As seen in FIG. 3B, the mounting assemblies 100, 105 accommodate thermal expansion in the height direction 80 by pivoting the recuperators 35 about the first and second pivot axes while moving the floating pivot axis vertically with respect to the first and second pivot axes. There is also a pivoting or bowing expansion (exaggerated in FIG. 3B for the purpose of illustration) of the recuperators 35 due to the thermal gradient caused by the flow of hot exhaust gases therethrough. The pivoting expansion causes the lower sides 173 and the matrix portions 60 of the recuperators 35 to bow. If one recuperator 35 expands more than the other, the floating pivot axis will also move toward the lessor-expanding recuperator 35 as the recuperators 35 grow in size.

The mounting assemblies 100, 105 also accommodate thermal expansion of the recuperators 35 in the stackwise 45 direction by sliding the arms 130 and plate extensions 125 along the pivot rods 110, 170 and tension rods 115, and accommodate thermal expansion in the width direction 75 by pivoting the arms 130 about the tension and pivot rods 115, 110, 170. Because the mounting assemblies 100, 105 accommodate thermal expansion in the stackwise, height, and width directions 45, 80, 75, and also in the a pivoting direction, they can be said to accommodate three degrees of recuperator thermal expansion and one degree of rotational expansion.

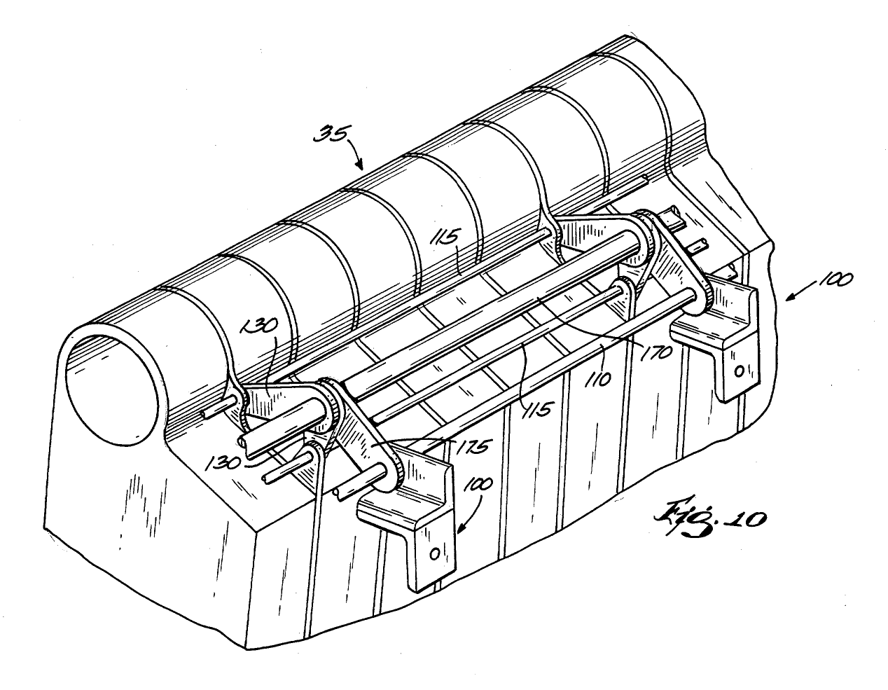

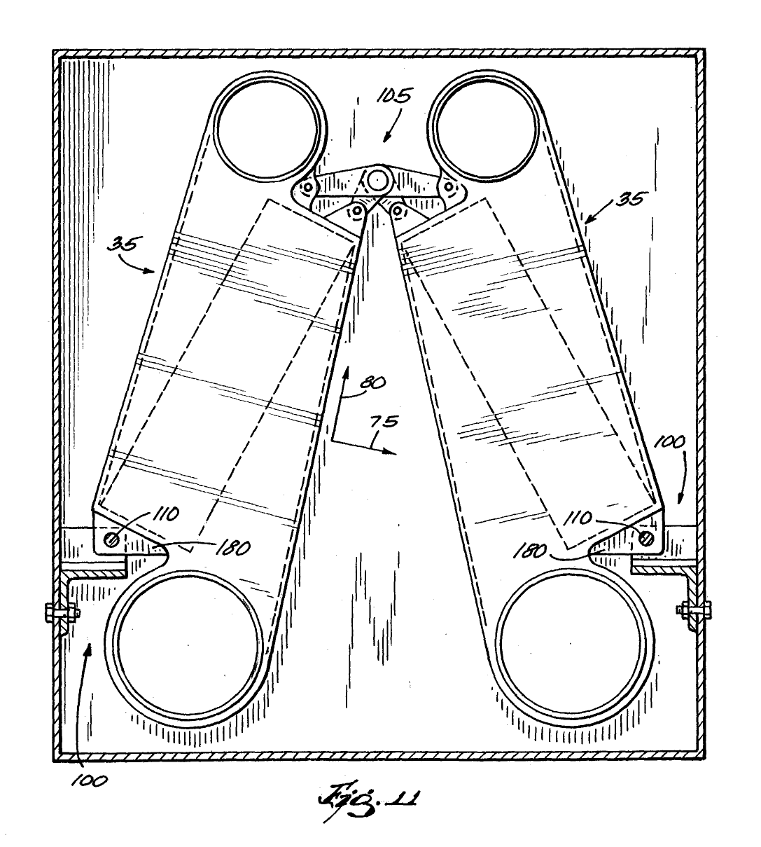

FIGS. 9 and 10 illustrate an alternative recuperator support construction for a single recuperator 35. This construction includes lower mounting assemblies 100 as described above. However, at each upper mounting assembly 105, the second recuperator 35, plate extensions 125, and arms 130 are replaced with a dummy link 175. For convenience, the lower mounting assemblies 100 for the dummy link 175 are moved up on the frame 95. The floating pivot rod 170 moves along an arc described by the pivotal movement of the dummy link 175 as the recuperator 35 undergoes thermal expansion.

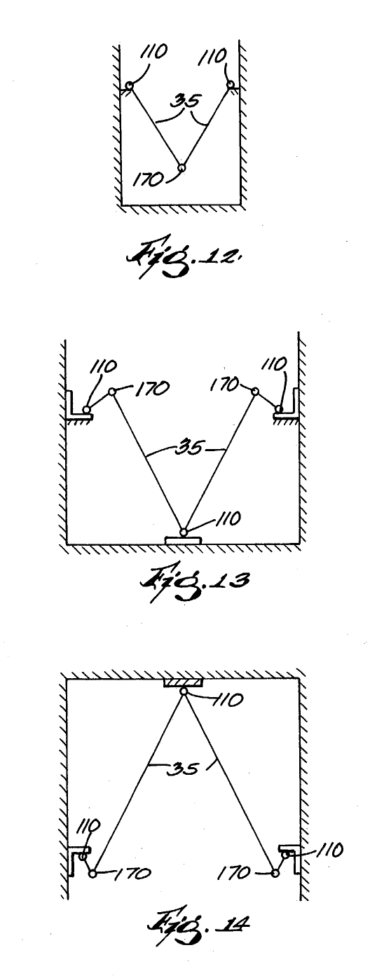

FIG. 11 illustrates a modification to the lower mounting assembly 100, in which the plate extensions 125, arms 130, and tension rods 115 described above are replaced with a single plate extension 180 that is pivotally mounted directly to the pivot bar 110. Although not illustrated, the same modification may be made to the upper mounting assembly 105. This modification reduces the number of components in the lower mounting assembly 100, but does not permit the lower mounting assembly 100 to accommodate thermal expansion in the width direction 75 to the extent of the previously-described lower mounting assembly 100.

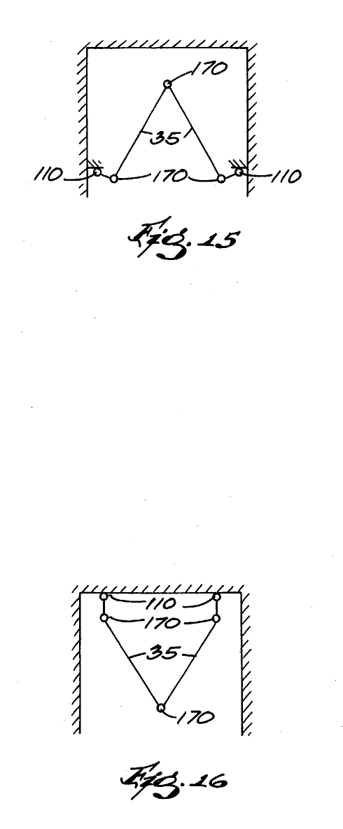

FIGS. 12-16 schematically illustrate alternative constructions of the recuperator support 90. In FIG. 12, the recuperators are inverted into a V-shape rather than the A-shape discussed above, and the floating pivot axis 170 is below the first and second pivot axes 110. In FIG. 13, the two recuperators are in the V configuration, and include three fixed-position pivot axis 110 and two floating pivot axes 170. FIG. 14 illustrates a construction similar to that of FIG. 13 but inverted. FIGS. 15 and 16 illustrate A and V configurations including three floating pivot axes 170 and two fixed axes 110. It should be noted that any of the constructions illustrated in FIGS. 12-16 may replace one of the recuperators with a dummy link 175 as described above with reference to FIGS. 9 and 10.

It should be appreciated that modifications to the above-described constructions may be made within the spirit and scope of the invention. For example, the illustrated construction includes two lower mounting assemblies 100 for each recuperator 35 and two upper mounting assemblies for the pair of recuperators 35, but the recuperators 35 may be supported by one or more than two lower and upper mounting assemblies 100, 105 for each recuperator 35. The latch assembly 145 described above may be modified (e.g., by using a linearly-actuated latch member rather than the illustrated pivotally actuated latch member 155) or removed. If the latch assembly 145 is removed, the slots 150 should be deep enough or curved to reduce the likelihood of inadvertent removal of the fixed-position pivot bars 110. Stop members may be employed to resist sliding the arms 130 and plate extensions 125 off the pivot and tension rods 110, 170, 115. Also, bearings or bushings may be employed to facilitate sliding the arms 130 and plate extensions 125 with respect to the pivot and tension rods 110, 170, 115.

It should also be appreciated that the invention is not limited to the plate-fin type heat exchangers illustrated. For example, the recuperators may be tube-type and/or crossflow-type heat exchangers. Also, the second recuperator may be of a different design or type than the first.

Although the invention has been described in detail with reference to certain preferred embodiments, variations and modifications exist within the scope and spirit of the invention as described and defined in the following claims.

1. A recuperator support for supporting a recuperator, the support comprising:
a first pivot mount defining a first pivot axis, the recuperator coupled to the first pivot mount and pivotal about the first pivot axis; and
a floating pivot mount defining a floating pivot axis that is movable with respect to the first pivot axis, the recuperator being coupled to the floating pivot mount and pivotal about the floating pivot axis.

2. The recuperator support of claim 1, wherein the floating pivot axis is movable with respect to the first pivot axis in response to thermal growth of the recuperator.

3. The recuperator support of claim 1, further comprising a frame, wherein the first pivot mount is fixed relative to the frame, and wherein the floating pivot mount is movable with respect to the frame.

4. The recuperator support of claim 3, further comprising a linking arm pivotally interconnected between the floating pivot mount and the frame such that the floating pivot mount is movable along an arcuate path with respect to the frame.

5. The recuperator support of claim 1, wherein said first pivot mount includes a pivot rod and a forked member receiving the pivot rod for pivotal motion within the forked member, the assembly further comprising a latch member selectively trapping the pivot rod within the forked member to resist removal of the pivot rod therefrom.

6. The recuperator support of claim 1, wherein the recuperator includes a first recuperator, the assembly further comprising a second recuperator coupled to a second pivot mount defining a second pivot axis, wherein both the first and second recuperators are coupled to the floating pivot mount and pivotal about the floating pivot axis.

7. The recuperator support of claim 6, wherein the floating pivot axis is movable with respect to both the first and second pivot axes in response to thermal growth of the first and second recuperators.

8. The recuperator support of claim 6, wherein the first and second pivot axes are generally parallel to each other.

9. The recuperator support of claim 8, wherein the floating pivot axis is generally parallel to both the first and second pivot axes.

10. The recuperator support of claim 6, further comprising a frame, wherein the first and second pivot mounts are both fixed with respect to the frame, and wherein the floating pivot mount is movable with respect to the frame.

11. The recuperator support of claim 6, wherein the first and second recuperators lean against each other and are arranged in a generally A-shaped configuration.

12. A recuperator support assembly comprising:
a first recuperator for the exchange of heat from a hot fluid flowing therethrough to a cool fluid flowing therethrough and expanding in response to heating by the hot fluid;
second recuperator for the exchange of heat from a hot fluid flowing therethrough to a cool fluid flowing therethrough and expanding in response to heating by the hot fluid; and
a frame supporting the first and second recuperators;
a first pivot mount defining a first pivot axis, the first recuperator being coupled to the first pivot mount such that the first recuperator is pivotal about the first pivot axis;
a second pivot mount defining a second pivot axis, the second recuperator being coupled to the second pivot mount such that the second recuperator is pivotal about the second pivot axis; and
a floating pivot mount defining a floating pivot axis that is movable with respect to the frame, the first and second recuperators both being coupled to the floating pivot mount such that the first and second recuperators are pivotal about the floating pivot axis.

13. The assembly of claim 12, wherein said first and second pivot mounts and said first and second pivot axes are all fixed with respect to said frame.

14. The recuperator support assembly of claim 12, wherein the first and second pivot mounts include first and second support rods, respectively, that define the first and second pivot axes, respectively.

15. The recuperator support assembly of claim 14, wherein the first and second support rods are fixed with respect to the respective first and second recuperators, and wherein the first and second pivot mounts each include an open-ended slot for receiving and pivotally supporting the respective first and second support rods.

16. The recuperator support assembly of claim 15, wherein the first and second pivot mounts further include first and second latch members, respectively, that selectively open and close the open-ended slots of the respective first and second pivot mounts, wherein the latches resist removal of the support rods from the open-ended slots when the latches close the open-ended slots, and wherein the latches do not resist removal of the support rods from the open-ended slots when the latches open the open-ended slots.

17. The recuperator support assembly of claim 12, wherein the floating pivot mount includes a support bar pivotally coupled to the first and second recuperators.

18. The recuperator support assembly of claim 12, wherein the floating pivot axis is spaced a distance from the first and second pivot axes, and wherein the distance between the floating pivot axis and the first and second pivot axes varies with the thermal expansion of the first and second recuperators.

19. The recuperator support assembly of claim 12, wherein said first, second, and floating axes are all generally parallel to each other.

20. The recuperator support assembly of claim 12, wherein said first and second recuperators lean against each other and are in a generally A-shaped configuration.

21. A microturbine engine comprising:
a recuperator having heat exchange cells, and exhaust gas flow regions between the heat exchange cells;
an air compressor in fluid communication with the heat exchange cells for the delivery of compressed air thereto;
a combustor in fluid communication with the heat exchange cells for the delivery of the compressed air from the cells to the combustor, the combustor burning fuel with the compressed air to create products of combustion;
a turbine in fluid communication with the combustor to receive the products of combustion therefrom, the turbine operating in response to the flow of products of combustion, the turbine including an exhaust gas outlet through which used products of combustion flow out of the turbine as exhaust gas, the recuperator receiving the flow of exhaust gas and passing it through the exhaust gas flow regions, the recuperator expanding in response to the flow of exhaust gas therethrough;
a fixed pivot mount defining a fixed pivot axis and supporting the recuperator for pivotal motion with respect to the fixed pivot axis; and
a floating pivot mount defining a floating pivot axis and supporting the recuperator for pivotal motion with respect to the floating pivot axis, wherein the floating pivot axis is movable with respect to the fixed pivot axis in response to expansion of the recuperator.

22. The engine of claim 21, wherein movement of the floating pivot axis with respect to the fixed pivot axis accommodates expansion of the recuperator.

23. The engine of claim 22, wherein the recuperator is a first recuperator and the fixed pivot mount is a first fixed pivot mount, the microturbine engine further comprising a second recuperator and a second fixed pivot mount, the second fixed pivot mount and floating pivot mount supporting the second recuperator such that the second recuperator is pivotal about the second fixed pivot axis and the floating pivot axis and the floating pivot axis is movable in response to expansion of the first and second recuperators.

24. The engine of claim 23, wherein movement of the floating pivot axis with resect to the first and second fixed pivot axes accommodates expansion of the first and second recuperators.

25. The engine of claim 23, wherein the first, second, and floating pivot axes are all generally parallel to each other.

26. The engine of claim 23, wherein said first and second recuperators lean against each other and are in a generally A-shaped configuration.

27. The engine of claim 21, further comprising a latch member selectively coupling the recuperator to the fixed pivot member.

28. The engine of claim 21, wherein the fixed pivot mount includes a pivot rod and a forked member receiving the pivot rod for pivotal motion within the forked member, the engine further comprising a latch member selectively trapping the pivot rod within the forked member to resist removal of the pivot rod therefrom.

29. A heat exchanger support configuration comprising:
a frame;
first and second pivot mounts interconnected with said frame such that said first and second pivot mounts are movable with respect to said frame, said first and second pivot mounts defining respective first and second floating pivot axes;
first and second recuperators pivotally interconnected with said first and second floating pivot mounts, respectively, for pivotal movement about said first and second, floating pivot axes; and
a fixed pivot mount affixed to said frame and defining a pivot axis that is fixed with respect to said frame, said fixed pivot mount interconnecting said first and second recuperators for pivotal movement with respect to each other;
wherein said floating pivot mounts are movable with respect to said frame in response to thermal expansion of said first and second recuperators.

30. The assembly of claim 29, further comprising pivot links interconnecting said first and second pivot mounts to said frame to permit said first and second floating pivot axes to move in a generally arcuate fashion with respect to said frame.

31. The assembly of claim 29, wherein said first and second recuperators lean against said fixed pivot mount and are in a generally A-shaped configuration.

32. The assembly of claim 29, wherein said first and second pivot mounts are above said fixed pivot mount such that said first and second recuperators are in a generally V-shaped configuration hanging from said first and second pivot mounts, and wherein said fixed pivot mount resists the first and second recuperators from disconnecting from each other under the influence of gravity.

33. The assembly of claim 29, wherein said first and second pivot mounts are below said fixed pivot mount such that said first and second recuperators are in a generally A-shaped configuration hanging from said fixed pivot mount, and wherein said first and second pivot mounts resist the first and second recuperators from disconnecting from said frame under the influence of gravity.

34. A method of supporting a recuperator subject to thermal expansion, the method comprising the steps of:
pivotally supporting the recuperator about first and second pivot axes with respective first and second support mounts; and
accommodating thermal expansion of the recuperator by moving the second pivot axis with respect to the first pivot axis.

35. The method of claim 34, further comprising the steps of:
providing a second recuperator subject to thermal expansion;
pivotally supporting the second recuperator about a third pivot axis and also about the second pivot axis; and
accommodating thermal expansion of the second recuperator by moving the second pivot axis with respect to the third pivot axis.

36. The method of claim 34, wherein said pivotally supporting step includes providing a frame, fixing the first pivot axis with respect to the frame, and permitting the second pivot axis to move with respect to the frame.

37. The method of claim 34, wherein said pivotally supporting step includes defining in the first support mount a slot, affixing a rod to the recuperator, and pivotally supporting the rod in the slot of the first support mount.

38. The method of claim 37, further actuating a latch to selectively capture the support rod in the slot.
